(19) United States
(12) Patent Application Publication
(10) Pub. No.: US 2003/0051207 A1
(43) Pub. Date: Mar. 13, 2003

(54) Photo album creating system, photo album creating method, and photo album creating program

(75) Inventors: Yutaka Kobayashi, Yokohama-shi (JP); Osamu Uchida, Yokohama-shi (JP); Sugio Makishima, Asaka-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/231,939

(22) Filed: Aug. 30, 2002

(30) Foreign Application Priority Data
Sep. 7, 2001 (JP) P2001-272123

(51) Int. Cl. G09G 5/00

(52) U.S. Cl. 715/500

(57) ABSTRACT

When a mobile phone or a PC transmits photograph information including image data of photographs, date/time information and location information when the photographs are picked up, and comments, etc. to a photo album creating system, the photograph information are stored in a photograph information storing section and then photo album date/time information and photo album location information are decided. Then, an external server transmits cover images, which conform to the photo album date/time information and the photo album location information or the comments sent from the photo album creating system, to the photo album creating system. After a photo album cover creating section creates a photo album cover based on respective cover images, a preview is transmitted. A photo album creating section creates the photo album by using the photo album cover or a layout, that is selected by a user.

### BACKGROUND OF THE INVENTION

1. Field of the Invention

The present invention relates to a photo album creating system, a photo album creating method, and a photo album creating program, which are capable of creating photographs, which are picked up by a digital camera, or the like, into a photo album in a desired mode.

2. Description of the Related Art

Conventionally, when people create a photo album of the photographs picked up by a digital camera or such, they edit a layout of photographs, or create a cover, or such by storing the photographs printed by the printer, or the like into the pocket photo album or by applying the photo album creating software while using the personal computer (referred simply to as “PC” hereinafter). In particular, since the photographs picked up by the digital camera are present as image data, which are available for the PC, and such photographs can be worked or edited freely according to the software if the PC is utilized, the nice-looking photo album can be created.

In this manner, either the photographs must be printed or the working process using the PC must be executed in creating the photo album in the method in the prior art, but it takes much time and labor to execute such operations at the personal level. Also, since the labor for shifting image data of the photographs into the PC or the labor for installing the photo album creating software, etc. into the PC is required in order to form the photo album by using the PC, such labors put the burden on the person in operation.

In addition, when the person creates the photo album by printing the photographs or using the software, normally the PC is required. If the person does not have the PC, or the PC is not present in the place, or if the photo album creating software, etc. are not installed into the PC even when the person has the PC, such person cannot form the photo album. Therefore, the technology by which the photo album can be created not to depend on the photo album creating software, etc. is demanded.

### SUMMARY OF THE INVENTION

The present invention has been made in view of the above circumstances in the related art, and it is an object of the present invention to provide a photo album creating system, a photo album creating method, and a photo album creating program, which are capable of creating photographs, that are picked up by an imaging means such as a digital camera, or the like, into a photo album by the person not to take time and labor.

In order to overcome the above problems, a photo album creating system of the present invention for creating a photo album based on images transmitted via a network, includes an image information receiving section for receiving image information including images and attached information of the images via a network; a cover image selecting section for selecting at least one candidate of cover images of the photo album to be created, based on the attached information included in the image information that are received by the image information receiving section; a photo album cover creating section for creating covers of the photo album by using the cover images that are selected by the cover image selecting section; and a photo album creating section for creating the photo album of the images included in the image information, which are received by the image information receiving section, in compliance with layout information that indicate how to layout a plurality of images, by using one of photo album covers, which are created by the photo album cover creating section, as the cover.

In this manner, if the communication terminal that can communicate with this photo album creating system is prepared, the photo album can be created in a desired mode only by transmitting the image data to the photo album creating system. Therefore, the photo album can be created only by transmitting the image without complicated operations not to take much time and labor.

Also, the photo album creating system of the present invention further includes a preview creating section for creating previews of either the photo album covers created by the photo album cover creating section or the photo album created in compliance with the layout information.

Also, in the photo album creating system of the present invention, if the cover image selecting section selects a plurality of cover images, the photo album creating section creates the photo album that uses a designated photo album cover as a cover.

Also, in the photo album creating system of the present invention, the photo album creating section creates the photo album in compliance with a designated layout information. Therefore, the photo album having a desired layout can be created.

Also, in the photo album creating system of the present invention, the attached information have date/time information or location information or comments when the images included in the image information are picked up, and the photo album creating system further comprises at least one of a photo album date/time information deciding section for deciding a photo album date/time information indicating a reference date/time of the photo album among the date/time information of the images constituting the photo album that is created by the photo album creating section; and a photo album location information deciding section for deciding a photo album location information indicating a representative shooting place of the photo album among the location information of the images constituting the photo album that is created by the photo album creating section; wherein the cover image selecting section selects a candidate of the cover images of the photo album, which is created by the photo album creating section, based on a word that is included in the photo album date/time information decided by the photo album date/time information deciding section, the photo album location information decided by the photo album location information deciding section, or the comments in the attached information. Therefore, the candidates of the photo album cover that are in conformity with contents of the photo album can be selected.

Also, in the photo album creating system of the present invention, the photo album cover creating section creates a cover of the photo album by using the cover images selected by the cover image selecting section and at least any one of the photo album date/time information and the photo album location information.

Also, a photo album creating method of the present invention employing a photo album creating system that creates a photo album based on images transmitted via a network, includes the steps of: image information receiving for receiving image information including images and attached information of the images via a network; cover image selecting for selecting at least one candidate of cover images of the photo album to be created, based on the attached information included in the image information that are received in the step of image information receiving; photo album cover creating for creating covers of the photo album by using the cover images that are selected in the step of cover image selecting; and photo album creating for creating the photo album of the images included in the image information, which are received in the step of image information receiving, in compliance with layout information that indicate how to layout a plurality of images, by using one of photo album covers, which are created in the step of photo album cover creating, as the cover.

Also, the photo album creating method of the present invention further includes a step of preview creating for creating previews of either the photo album covers created in the step of photo album cover creating or the photo album created in compliance with the layout information.

Also, in the photo album creating method of the present invention, if a plurality of cover images are selected in the step of cover image selecting, in the step of photo album creating, the photo album, that uses a designated photo album cover as a cover, is created.

Also, in the photo album creating method of the present invention, in the step of photo album creating, the photo album is created in compliance with a designated layout information.

Also, in the photo album creating method of the present invention, the attached information have date/time information or location information or comments when the images included in the image information are picked up, and the photo album creating method further includes at least one of the steps of: photo album date/time information deciding for deciding a photo album date/time information indicating a reference date/time of the photo album among the date/time information of the images constituting the photo album that is created by the photo album creating step; and photo album location information deciding for deciding a photo album location information indicating a representative shooting place of the photo album among the location information of the images constituting the photo album that is created by the photo album creating step; wherein, in the step of cover image selecting, a candidate for the cover images of the photo album, which is created in the step of photo album creating, is selected based on the photo album date/time information decided in the step of photo album date/time information deciding, the photo album location information decided in the step of photo album location information deciding, or a word included in the comments in the attached information.

Also, in the photo album creating method of the present invention, in the step of photo album cover creating, a cover of the photo album is created by using the cover images selected in the step of cover image selecting and at least any one of the photo album date/time information and the photo album location information.

In addition, a photo album creating program of the present invention for operating a computer as respective sections included in the photo album creating system set forth in any one of the systems explained above.

### BRIEF DESCRIPTION OF THE DRAWINGS

FIG. 1 is a block diagram showing a photo album creating system according to an embodiment of the present invention.

In the FIGURE, the reference numeral 101 refers to a photo album creating system; 103 to a mobile phone; 105 to a personal computer (PC); 107 to an external server; 111 to a network; 201 to a network connection section; 203 to a user information storing section: 205 to a user identification section; 207 to a photograph information storing section; 209 to a photo album date/time information deciding section; 211 to a photo album location information deciding section; 213 to a photo album cover creating section; 215 to a photo album cover storing section; 217 to a layout information storing section; 219 to a preview creating section; and 221 to a photo album creating section.

### DETAILED DESCRIPTION OF THE PREFERRED EMBODIMENTS

A photo album creating system according to an embodiment, which is explained in the following, is such a system that can create a photo album in a desired mode if the user of this system only transmits image data of photographs picked up by the digital camera, or the like and then gives the simple instruction. The embodiment of the photo album creating system according to the present invention will be explained in detail with reference to the drawing in the following. In the embodiment explained in the following, a photo album creating system and a photo album creating method will be explained in detail. It should be interpreted that, since a photo album creating program according to the present invention is applied to execute the photo album creating method, explanations about the photo album creating program are included in the photo album creating method described later.

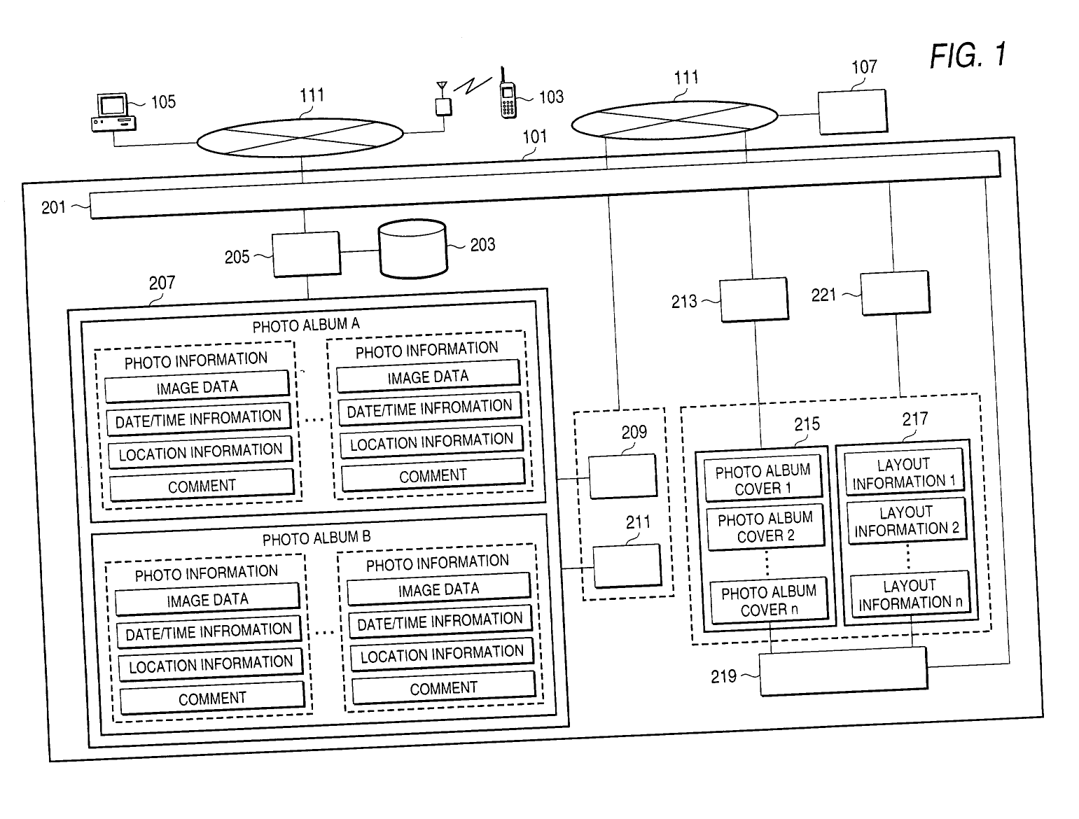

FIG. 1 is a block diagram showing the photo album creating system according to the embodiment of the present invention. In the photo album creating system according to the present embodiment shown in FIG. 1, centering around a photo album creating system 101, each of a mobile phone 103, a personal computer (PC) 105, and an external server 107, which corresponds to a cover image selecting section in Claims, is connected to the photo album creating system 101 via networks 111.

Respective constituent elements of the photo album creating system 101 according to the present embodiment will be explained hereunder.

First, the mobile phone 103 and the PC 105 transmit photograph information such as image data of the photographs picked up by the digital camera or such, date/time information and location information of the picked-up photographs, comments, and user information such as the user ID, the password, or such to the photo album creating system 101. The location information can be obtained from a base station if the mobile phone 103 is employed or can be obtained from the access point if the PC is employed. Also, as another method, the location information may be obtained by using GPS.

The external server 107 is a server that can store plural types of images, each of which is used as a cover of the photo album created by the photo album creating system 101 (referred to as “cover images” hereinafter) and can communicate with the photo album creating system 101 via the network 111. The external server 107 uses a word included in the photo album date/time information and the photo album location information (described later) and the comments, which are transmitted from the photo album creating system 101 via the network 111, as a key word, then selects the cover image, preferably plural sheets of images, which correspond to this key word, and then transmits such cover images to the photo album creating system 101. In this case, the external server 107 may be provided to an inside of the photo album creating system 101.

The photo album creating system 101 creates the photo album from the photograph information based on the instruction from the user of the mobile phone 103 or the PC 105, which transmits the photograph information. As shown in FIG. 1, the photo album creating system 101 is constructed such that includes a network connection section 201 that corresponds to an image information receiving section in Claims, a user information storing section 203, a user identification section 205, a photograph information storing section 207, a photo album date/time information deciding section 209, a photo album location information deciding section 211, a photo album cover creating section 213, a photo album cover storing section 215, a layout information storing section 217, a preview creating section 219, and a photo album creating section 221.

Next, the network connection section 201 receives the photograph information or the user information from the mobile phone 103 or the PC 105 via the network 111, and sends out preview images that are prepared by the preview creating section 219. Also, the network connection section 201 transmits the photo album date/time information, the photo album location information, the comments, etc. included in the photograph information, to be described later, to the external server 107 via the network 111, and receives a plurality of cover images from the external server 107. In addition, the network connection section 201 transmits the photo album, which is prepared by the photo album creating section 221, to a predetermined terminal. Also, the user information storing section 203 stores information about the user of the present system. Also, the user identification section 205 identifies the user, who is indicated by the user information received by the network connection section 201, by looking up the information stored in the user information storing section 203, and then authenticates the user based on the password.

Also, the photograph information storing section 207 stores the photograph information received by the network connection section 201. The photograph information are put together every photo album. Also, the photo album date/time information deciding section 209 decides photo album date/time information indicating reference date/time of the photo album prepared by the photo album location information deciding section 211. The photo album date/time information can be obtained by calculating an average value of the date/time information of respective photograph information, which constitute the photo album and are stored in the photograph information storing section 207. The photo album location information deciding section 211 decides the photo album location information that indicate the representative shooting place of the photo album that is prepared by the photo album creating section 221. The photo album location information are defined as the location information that appears most-highly frequently in the location information of respective photograph information constituting the photo album and stored in the photograph information storing section 207.

The photo album cover creating section 213 creates a cover of the photo album (referred to as an “photo album cover” hereinafter) from the cover images, which are transmitted from the external server 107, and various information such as the photo album date/time information, the photo album location information, the user information, etc. In this case, if a plurality of cover images are transmitted from the external server 107, the photo album cover is created every cover image. Also, the photo album cover storing section 215 stores the photo album covers prepared by the photo album cover creating section 213. In this case, if plural types of photo album covers are stored in the photo album cover storing section 215, one of plural photo album covers is selected by the user. If no photo album cover is selected by the user, any one of the photo album covers is selected as the default.

Also, the layout information storing section 217 stores plural types of layout information indicating how to layout the photographs in the photo album, which is to be created by the photo album creating section 221. Like the photo album cover, any one of the layout information is selected by the user. If no layout information is selected by the user, any one of the layout information is selected as the default. Also, the preview creating section 219 creates previews of either respective covers of the photo album stored in the photo album cover storing section 215 or the photo album created in compliance with respective layout information stored in the layout information storing section 217. The created previews are transmitted from the network connection section 201 to the mobile phone 103 or the PC 105. The user can select the cover or the layout of the photo album to be employed, by looking up the sent preview.

Also, the photo album creating section 221 creates the photo album, in which the photographs are arranged in the layout selected by the user, by using the photograph information (in particular, the image data and the comments) stored in the photograph information storing section 207 and the photo album cover selected by the user. The photo album being created by the photo album creating section 221 is saved as the electronic data or is printed. In this case, the electronic data of the photo album may be transmitted to a predetermined terminal via the network connection section 201.

Next, the photo album creating method utilizing the photo album creating system according to the present embodiment will be explained hereunder.

First, the user of the present system stores the image data of the photographs picked up by the digital camera, or the like in the mobile phone 103 or the PC 105. Then, the user selects the photographs, which are to be transmitted to the photo album creating system 101, by operating the mobile phone 103 or the PC 105. Then, the user inputs the comments if such comments are attached to respective photographs, and also inputs the date/time information or the location information unless such information are affixed to the image data of the photographs. The mobile phone 103 or the PC 105 generates the photograph information including the image data, the date/time information, the location information, and the comments, and then transmits the photograph information as well as the user information to the photo album creating system 101.

When the network connection section 201 in the photo album creating system 101 receives the photograph information and the user information, the user identification section 205 identifies the user based on the user information. If the user is validly identified, the photograph information are stored in the photograph information storing section 207. Then, the photo album date/time information deciding section 209 reads respective date/time information of the photographs, which constitute the photo album to be created subsequently, from the photograph information storing section 207, and then decides the photo album date/time information by calculating an average value of them. Also, the photo album location information deciding section 211 reads respective location information of the photographs, which constitute the photo album to be created subsequently, from the photograph information storing section 207, and then decides the location information, which appears most-highly frequently, as the photo album location information.

Then, the photo album date/time information decided by the photo album date/time information deciding section 209 and the photo album location information decided by the photo album location information deciding section 211, and the comments included in the photograph information are sent out from the network connection section 201 to the external server 107 via the network 111. When the external server 107 receives these information, such external server 107 uses the word included in the photo album date/time information and the photo album location information and the comments as a key word, and then selects the cover image, preferably plural sheets of images, which correspond to this key word. Then, the external server 107 transmits the selected cover images to the photo album creating system 101 via the network 111.

When the network connection section 201 of the photo album creating system 101 received the cover images from the external server 107, such cover images are transmitted to the photo album cover creating section 213. The photo album cover creating section 213 created the photo album covers every cover image based on various information such as the photo album date/time information, the photo album location information, and the user information, etc., and then stores them in the photo album cover storing section 215. The previews of respective photo album covers, which are stored in the photo album cover storing section 215, are created in the preview creating section 219, and then transmitted from the network connection section 201 to the mobile phone 103 or the PC 105. Similarly, the previews, in which the photographs of the image data stored in the photograph information storing section 207 are arranged based on respective layout information stored in the layout information storing section 217, are created in the preview creating section 219, and then transmitted from the network connection section 201 to the mobile phone 103 or the PC 105.

The user of the mobile phone 103 or the PC 105 selects the photo album cover or the layout to be employed, by referring to the previews transmitted from the photo album creating system 101. Then, the photo album creating section 221 uses the photo album cover selected by the user or given as the default as the cover, and then creates the photo album in which the photographs of the image data stored in the photograph information storing section 207 are arranged based on the layout selected by the user or given as the default. The photo album created by the photo album creating section 221 is saved as the electronic data as it is, or is printed, or transmitted from the network connection section 201 to a predetermined terminal. Thus, a series of processes required for the photo album formation are ended.

As described above, in the photo album creating system and the photo album creating method according to the present embodiment, if the communication terminal such as the mobile phone 103, the PC 105, or the like, which can communicate with the photo album creating system 101, is prepared, the photo album creating system 101 can form the photo album in the user's desired mode when the user only transmits the image data of the photographs picked up by the digital camera, or the like to the photo album creating system 101 and also gives the simple instruction to the photo album creating system 101. Therefore, if the user of the present system transmits the image data and gives the simple instruction without complicated operations, such user can form the photo album not to take much time and labor.

Also, any terminal may be employed as the mobile phone 103, the PC 105 if such terminal can store and transmit the image data to selectively instruct the photo album cover or the layout and thus the special software such as the photo album creating software, or the like is not employed. Therefore, the photo album creating system that is independent of the terminal can be provided.

In addition, the external server 107 selects the candidates of the cover image by using the word, which is included in the photo album date/time information and the photo album location information or the comments, as the key word. Therefore, the cover image that conforms to the contents of the photo album can be selected.

As described above, according to the photo album creating system, the photo album creating method and the photo album creating program of the present invention, if the communication terminal that can communicate with the photo album creating system is prepared, the photo album can be created in the desired mode only by transmitting the image data to the photo album creating system. Therefore, the photo album can be created only by transmitting the image without the complicated operations not to take much time and labor.

What is claimed is:

1. A photo album creating system for creating a photo album based on images transmitted via a network, the system comprising:
an image information receiving section for receiving image information including images and attached information of the images via a network;
a cover image selecting section for selecting at least one candidate for a cover image of the photo album to be created, based on the attached information included in the image information that are received by the image information receiving section;
a photo album cover creating section for creating covers of the photo album by using the cover images that are selected by the cover image selecting section; and
a photo album creating section for creating the photo album of the images included in the image information, which are received by the image information receiving section, in compliance with layout information that indicate how to layout a plurality of images, by using one of photo album covers, which are created by the photo album cover creating section, as the cover.

2. The photo album creating system according to claim 1, further comprising:
a preview creating section for creating previews of either the photo album covers created by the photo album cover creating section or the photo album created in compliance with the layout information.

3. The photo album creating system according to claim 1,
wherein, if the cover image selecting section selects a plurality of cover images, the photo album creating section creates the photo album that uses a designated photo album cover as a cover.

4. The photo album creating system according to claim 2,
wherein, if the cover image selecting section selects a plurality of cover images, the photo album creating section creates the photo album that uses a designated photo album cover as a cover.

5. The photo album creating system according to claim 1,
wherein the photo album creating section creates the photo album in compliance with a designated layout information.

6. The photo album creating system according to claim 2,
wherein the photo album creating section creates the photo album in compliance with a designated layout information.

7. The photo album creating system according to claim 1,
wherein the attached information includes at least any one of date/time information, location information, and comments when the images included in the image information are picked up, and the system further comprising at least one of:
a photo album date/time information deciding section for deciding a photo album date/time information indicating a reference date/time of the photo album among the date/time information of the images constituting the photo album that is created by the photo album creating section; and
a photo album location information deciding section for deciding a photo album location information indicating a representative shooting place of the photo album among the location information of the images constituting the photo album that is created by the photo album creating section;
wherein the cover image selecting section selects a candidate for the cover image of the photo album, which is created by the photo album creating section, based on the photo album date/time information decided by the photo album date/time information deciding section, the photo album location information decided by the photo album location information deciding section, or a word included in the comments in the attached information.

8. The photo album creating system according to claim 2,
wherein the attached information includes at least any one of date/time information, location information, and comments when the images included in the image information are picked up, and the system further comprising at least one of:
a photo album date/time information deciding section for deciding a photo album date/time information indicating a reference date/time of the photo album among the date/time information of the images constituting the photo album that is created by the photo album creating section; and
a photo album location information deciding section for deciding a photo album location information indicating a representative shooting place of the photo album among the location information of the images constituting the photo album that is created by the photo album creating section;
wherein the cover image selecting section selects a candidate for the cover image of the photo album, which is created by the photo album creating section, based on the photo album date/time information decided by the photo album date/time information deciding section, the photo album location information decided by the photo album location information deciding section, or a word included in the comments in the attached information.

9. A photo album creating system according to claim 7,
wherein the photo album cover creating section creates a cover of the photo album by using the cover images selected by the cover image selecting section and at least any one of the photo album date/time information and the photo album location information.

10. A photo album creating system according to claim 8,
wherein the photo album cover creating section creates a cover of the photo album by using the cover images selected by the cover image selecting section and at least any one of the photo album date/time information and the photo album location information.

11. A photo album creating method employing a photo album creating system that creates a photo album based on images transmitted via a network, comprising the steps of:
image information receiving for receiving image information including images and attached information of the images via a network;
cover image selecting for selecting at least one candidate of cover images of the photo album to be created, based on the attached information included in the image information that are received by the step of image information receiving;
photo album cover creating for creating covers of the photo album by using the cover images that are selected by the step of cover image selecting; and
photo album creating for creating the photo album of the images included in the image information, which are received by the step of image information receiving, in compliance with layout information that indicate how to layout a plurality of images, by using one of photo album covers, which are created by the photo album cover creating step, as the cover.

12. The photo album creating method according to claim 11, further comprising the step of:
preview creating for creating previews of either the photo album covers created by the photo album cover creating step or the photo album created in compliance with the layout information.

13. The photo album creating method according to claim 11,
wherein, if a plurality of cover images are selected in the step of cover image selecting, in the step of photo album creating, the photo album that uses a designated photo album cover as a cover is created.

14. The photo album creating method according to claim 12,
wherein, if a plurality of cover images are selected in the step of cover image selecting, in the step of photo album creating, the photo album that uses a designated photo album cover as a cover is created.

15. The photo album creating method according to claim 11,
wherein, in the step of photo album creating, the photo album is created in compliance with a designated layout information.

16. The photo album creating method according to claim 12,
wherein, in the step of photo album creating, the photo album is created in compliance with a designated layout information.

17. The photo album creating method according to claim 11,
wherein the attached information have date/time information or location information or comments when the images included in the image information are picked up, and the method further comprising at least any one of the steps of:
photo album date/time information deciding for deciding a photo album date/time information indicating a reference date/time of the photo album among the date/time information of the images constituting the photo album that is created in the step of photo album creating; and
photo album location information deciding for deciding a photo album location information indicating a representative shooting place of the photo album among the location information of the images constituting the photo album that is created in the step of photo album creating;
wherein, in the step of cover image selecting, a candidate for the cover image of the photo album created in the step of photo album creating is selected based on the photo album date/time information decided in the step of photo album date/time information deciding, the photo album location information decided in the step of photo album location information deciding, or a word included in the comments in the attached information.

18. The photo album creating method according to claim 12,
wherein the attached information have date/time information or location information or comments when the images included in the image information are picked up, and the method further comprising at least any one of the steps of:
photo album date/time information deciding for deciding a photo album date/time information indicating a reference date/time of the photo album among the date/time information of the images constituting the photo album that is created in the step of photo album creating; and
photo album location information deciding for deciding a photo album location information indicating a representative shooting place of the photo album among the location information of the images constituting the photo album that is created in the step of photo album creating;
wherein, in the step of cover image selecting, a candidate for the cover image of the photo album created in the step of photo album creating is selected based on the photo album date/time information decided in the step of photo album date/time information deciding, the photo album location information decided in the step of photo album location information deciding, or a word included in the comments in the attached information.

19. The photo album creating method according to claim 17,
wherein, in the step of photo album cover creating, a cover of the photo album is created by using the cover images selected in the steps of cover image selecting and at least any one of the photo album date/time information and the photo album location information.

20. The photo album creating method according to claim 18,
wherein, in the step of photo album cover creating, a cover of the photo album is created by using the cover images selected in the steps of cover image selecting and at least any one of the photo album date/time information and the photo album location information.

21. A photo album creating program for operating a computer as respective sections included in the photo album creating system set forth in claim 1.

22. A photo album creating program for operating a computer as respective sections included in the photo album creating system set forth in claim 2.
